(19) United States
(12) Patent Application Publication
(10) Pub. No.: US 2006/0244889 A1
(43) Pub. Date: Nov. 2, 2006

(54) Liquid crystal display and manufacturing method of the same

(76) Inventors: Ji-won Sohn, Seoul (KR); Nak-cho Choi, Seoul (KR)

Correspondence Address: CANTOR COLBURN, LLP, 55 GRIFFIN ROAD SOUTH, BLOOMFIELD, CT, 06002, US

(21) Appl. No.: 11/359,230

(22) Filed: Feb. 22, 2006

(30) Foreign Application Priority Data
May 2, 2005 (KR) 2005-0036796

(51) Int. Cl. G02F 1/1343

(52) U.S. Cl. 349/143

(57) ABSTRACT

An LCD includes first and second insulating substrates with liquid crystal disposed therebetween, first and second gate lines, a data line crossed and insulated with the gate lines, thereby defining a pixel area, a pixel electrode formed in the pixel area and having a pixel electrode cutting pattern, a direction control electrode line electrically separated from the pixel electrode, at least partly overlapped with the pixel electrode cutting pattern and controlling the liquid crystal layer, a TFT for the pixel electrode formed in an area where the first gate line and the data line are crossed and connected to the pixel electrode, and a TFT for a direction control electrode formed in an area where the second gate line and the data line are crossed and connected to the direction control electrode line. Accordingly, an LCD realizes a wide angular field and improves a response time of a liquid crystal.

This application claims priority to Korean Patent Application No. 2005-0036796, filed on May 2, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) and a manufacturing method of the same. More particularly, the present invention relates to an LCD and a manufacturing method of the same dividing a single pixel into a plurality of domains, thereby realizing a wide angular field and improving response time of a liquid crystal.

2. Description of the Related Art

A liquid crystal display (“LCD”) is widely used as a flat panel display since it is not only slim and light, but it also consumes less electric power than a cathode-ray tube (“CRT”).

The LCD includes an LCD panel having a thin film transistor (“TFT”) substrate on which TFTs are formed, a color filter substrate on which color filter layers are formed, and liquid crystal disposed therebetween. Since the LCD panel does not emit light by itself, the LCD may further include a backlight unit disposed in rear of the TFT substrate to provide light. A molecular alignment of the liquid crystal is adjusted depending on a fringe field formed between the TFT substrate and the color filter substrate by applying voltages to a pixel electrode on the TFT substrate and to a common electrode on the color filter substrate. The transmittance of the light emitted from the backlight unit is adjusted depending on the molecular alignment of the liquid crystal, thereby forming an image on the LCD panel.

Since LCDs are employed within TVs and large-sized display devices using moving images, response time of a liquid crystal and a wide angular field are highly recognized and desirable features.

In order to realize a wide angular field and improve response time of a liquid crystal, a cutting pattern or a projection is formed on a pixel electrode and on a common electrode. A traveling domain, where liquid crystal molecules tilt in different directions, is formed by using a fringe field formed by the cutting pattern or the projection of the pixel electrode or common electrode. Accordingly, by controlling a lying direction of liquid crystal molecules, thereby widening an angular field and deciding a tilting direction of the liquid crystal molecules in advance, thereby improves response time.

However, an aforementioned method of providing the cutting pattern and the projection has a disadvantage, that is, an additional process is needed to form the cutting pattern or the projection on the pixel electrode and on the common electrode, respectively. Moreover, since the liquid crystal molecules adjacent to the cutting pattern or the projection are strongly influenced by the fringe field, they are quickly realigned, but the liquid crystal molecules far from the cutting pattern or the projection are instead influenced by the liquid crystal molecules adjacent to the cutting pattern or the projection and are then realigned, therefore the response time of the liquid crystal molecules far from the cutting pattern or the projection is disadvantageously slow.

In addition, in case of a weak fringe field by the cutting pattern, the liquid crystal molecules are not properly oriented and the response time of the liquid crystal is disadvantageously slow.

### BRIEF SUMMARY OF THE INVENTION

Accordingly, it is an aspect of the present invention to provide a liquid crystal display (“LCD”) and a manufacturing method of the same realizing a wide angular field and improving a response time of a liquid crystal.

The foregoing and/or other aspects of the present invention are achieved by providing an LCD including a first insulating substrate, a second insulating substrate, a liquid crystal layer disposed between the first insulating substrate and the second insulating substrate, a first gate line and a second gate line formed on the first insulating substrate in a widthwise direction, a data line crossed with and insulated from the gate lines, thereby defining a pixel area, a pixel electrode formed in the pixel area and including a pixel electrode cutting pattern, a direction control electrode line electrically separated from the pixel electrode, at least partly overlapped with the pixel electrode cutting pattern, and controlling the liquid crystal layer, a first TFT for the pixel electrode formed in an area where the first gate line and the data line are crossed and connected to the pixel electrode, and a second TFT for a direction control electrode formed in an area where the second gate line and the data line are crossed and connected to the direction control electrode line.

According to embodiments of the present invention, the pixel electrode cutting pattern includes a first pixel electrode cutting pattern formed substantially parallel to the second gate line and dividing the pixel electrode symmetrically in two sections up and down, and a second pixel electrode cutting pattern, a third pixel electrode cutting pattern, and a fourth pixel electrode cutting pattern formed in an oblique direction and divided in two symmetrically up and down by the first pixel electrode cutting pattern on the pixel electrode.

According to embodiments of the present invention, the second pixel electrode cutting pattern is disposed near to the first pixel electrode cutting pattern, and the third pixel electrode cutting pattern and the fourth pixel electrode cutting pattern are disposed parallel with and spaced from the second pixel electrode cutting pattern.

According to embodiments of the present invention, the direction control electrode line is at least partly overlapped with the first, the second, and the fourth pixel electrode cutting pattern.

According to embodiments of the present invention, the direction control electrode line includes one part parallel with the data line and another part extended in an oblique direction and overlapped with the pixel electrode cutting pattern.

According to embodiments of the present invention, the direction control electrode line and the data line are formed in a same layer of the LCD.

According to embodiments of the present invention, the second TFT includes a gate electrode connected to the second gate line, a source electrode branched off from the data line and formed on the gate electrode, and a drain electrode disposed opposite to the source electrode, and the direction control electrode line is connected to the drain electrode.

According to embodiments of the present invention, the gate electrode, the source electrode, and the drain electrode of the second TFT are a second gate electrode, a second source electrode, and a second drain electrode, and the first TFT includes a first gate electrode connected to the first gate line, a first source electrode branched off from the data line and formed on the first gate electrode, and a first drain electrode disposed opposite to the first source electrode, and the pixel electrode is connected to the first drain electrode.

According to embodiments of the present invention, width of the pixel electrode cutting pattern and width of the direction control electrode line are in a range of from about 1 to about 16 μm.

According to embodiments of the present invention, the LCD further includes a gate driving part applying a gate signal to the gate lines, a data driving part applying a data signal to the data line, and a signal control part controlling the gate driving part and the data driving part, wherein the signal control part controls the data driving part so that voltage applied to the direction control electrode line may be about 0.5 to about 5V higher than voltage applied to the pixel electrode.

According to embodiments of the present invention, the signal control part controls the data driving part so that the direction control electrode line and the pixel electrode are applied with voltage having same polarity.

According to embodiments of the present invention, the signal control part controls the gate driving part so that the second TFT turns on before the first TFT turns on and the second TFT turns off before the first TFT turns off.

According to embodiments of the present invention, the signal control part controls the gate driving part so that the gate signal applied to the second TFT rises and falls before the gate signal applied to the first TFT rises and falls.

According to embodiments of the present invention, the first TFT and the second TFT are driven independently.

According to embodiments of the present invention, the LCD further includes a common electrode disposed opposite to the first insulating substrate and formed on the second insulating substrate, and an organic layer mountain structure-type pattern formed on the common electrode and projected to the first insulating substrate with a mountain shape having a predetermined slant.

According to embodiments of the present invention, the mountain shape has a substantially triangular-shaped cross-section.

According to embodiments of the present invention, the organic layer mountain structure-type pattern is divided apart by an organic layer cutting pattern in a predetermined shape.

According to embodiments of the present invention, a top of the organic layer mountain structure-type pattern is formed corresponding to a location of the direction control electrode line.

According to embodiments of the present invention, the common electrode is formed on an entire area of the pixel area.

According to embodiments of the present invention, the organic layer mountain structure-type pattern is formed in a taper structure becoming gradually thinner from the top to a verge.

According to embodiments of the present invention, a slant of a taper of the organic layer mountain structure-type pattern is in a range of from about 1 to about 5 degrees.

According to embodiments of the present invention, the thickness of a top of the organic layer mountain structure-type pattern is in a range of from about 0.5 to about 3 μm.

According to embodiments of the present invention, a projection projected to the first insulating substrate is formed on a portion of the organic layer mountain structure-type pattern.

According to embodiments of the present invention, the projection is aligned with the direction control electrode line.

According to embodiments of the present invention, the LCD further includes a common electrode disposed opposite to the first insulating substrate and formed on the second insulating substrate, and a column spacer projected to the first insulating substrate and formed on the common electrode.

According to embodiments of the present invention, the column spacer is formed corresponding to at least one place among the TFTs formed on the first insulating substrate, the gate lines, the data line, and an area where the gate lines and the data line are crossed.

The foregoing and/or other aspects of the present invention are also achieved by providing a TFT substrate including an insulating substrate, a first gate line and a second gate line formed on the insulating substrate in a width direction, a date line crossed with and insulated from the gate lines, thereby defining a pixel area, a pixel electrode formed in the pixel area and having a pixel electrode cutting pattern, a direction control electrode line electrically separated from the pixel electrode, at least partly overlapped with the pixel electrode cutting pattern and controlling a liquid crystal layer; a first TFT for the pixel electrode formed in an area where the first gate line and the data line are crossed and connected to the pixel electrode, and a second TFT for a direction control electrode formed in an area where the second gate line and the data line are crossed and connected to the direction control electrode line.

The foregoing and/or other aspects of the present invention are also achieved by providing a method of manufacturing an LCD including providing a first insulating substrate and a second insulating substrate, forming a first gate line and a second gate line spaced apart by a predetermined distance on the first insulating substrate, providing a data line crossed with and insulated from the first gate line and the second gate line, thereby defining a pixel area, a first TFT for a pixel electrode disposed on an area where the first gate line is crossed with the data line, and a second TFT for a direction control electrode having a portion of the direction control electrode line disposed on an area where the second gate line is crossed with the data line, forming a pixel electrode including a pixel electrode cutting pattern, and interposing a liquid crystal layer between the first insulating substrate and the second insulating substrate.

According to embodiments of the present invention, forming the pixel electrode having a pixel electrode cutting pattern includes forming a first pixel electrode cutting pattern substantially parallel to the gate lines and dividing the pixel electrode symmetrically in two sections up and down, and forming a second pixel electrode cutting pattern, a third pixel electrode cutting pattern, and a fourth pixel electrode cutting pattern in an oblique direction and divided in two symmetrically up and down by the first pixel electrode cutting pattern on the pixel electrode.

According to embodiments of the present invention, forming the pixel electrode further includes providing the second pixel electrode cutting pattern next to the first pixel electrode cutting pattern and providing the third pixel electrode cutting pattern and the fourth pixel electrode cutting pattern parallel with and spaced from the second pixel electrode cutting pattern.

According to embodiments of the present invention, the direction control electrode line is formed to be at least partly overlapped with the first, the second, and the fourth pixel electrode cutting patterns.

According to embodiments of the present invention, the direction control electrode line is formed with one part parallel with the data line and another part extended in an oblique direction and overlapped with the pixel electrode cutting pattern.

According to embodiments of the present invention, the direction control electrode line and the data line are formed at substantially a same time.

According to embodiments of the present invention, the method of manufacturing an LCD further includes forming a common electrode on the second insulating substrate and an organic layer mountain structure-type pattern on the common electrode and projected to the first insulating substrate with a mountain shape having a predetermined slant.

According to embodiments of the present invention, the method of manufacturing an LCD further includes forming a projection projected to the first insulating substrate on a portion of the organic layer mountain structure-type pattern.

According to embodiments of the present invention, forming the projection includes forming the projection on a portion of the organic layer mountain structure-type pattern positioned closest to the first insulating substrate.

According to embodiments of the present invention, forming the projection includes aligning the projection with the direction control electrode line.

According to embodiments of the present invention, the method of manufacturing an LCD further includes forming a common electrode on the second insulating substrate and forming a column spacer projected to the first insulating substrate on the common electrode.

According to embodiments of the present invention, the column spacer is formed in a location corresponding to at least one place among the TFTs formed on the first insulating substrate, the data line, the gate lines, and an area where the gate lines and the data line are crossed.

According to embodiments of the present invention, forming the column spacer including forming the column spacer with the organic layer mountain structure-type pattern or the projection at a substantially same time.

According to embodiments of the present invention, the method of manufacturing an LCD further includes forming the direction control electrode line at a substantially same time as providing the data line.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an arrangement view of a first exemplary embodiment of a TFT substrate according to the present invention;

FIG. 2 is a sectional view of an LCD, taken along line II-II of FIG. 1;

FIG. 3 is a plan view of the first exemplary embodiment of a pixel electrode cutting pattern according to the present invention;

FIG. 4 is a circuit diagram of the first exemplary embodiment of the LCD according to the present invention;

FIG. 5 is a block diagram showing an exemplary driving principle of the first exemplary embodiment of the LCD according to the present invention;

FIGS. 6A and 6B are graphs illustrating an exemplary driving method of the first exemplary embodiment of the LCD according to the present invention;

FIG. 7 is a sectional view of a second exemplary embodiment of an LCD according to the present invention; and

FIG. 8 is a sectional view of a third exemplary embodiment of an LCD according to the present invention.

### DETAILED DESCRIPTION OF THE INVENTION

Reference will now be made in detail to exemplary embodiments of the present invention, examples of which are illustrated in the accompanying drawings, wherein like reference numerals refer to like elements throughout. In the drawings, the thickness of layers, films, and regions are exaggerated for clarity. The embodiments are described below in order to explain the present invention by referring to the figures, however the exemplary embodiments and figures are only illustrative of the present invention, and not intended to limit the scope of the present invention.

In the following description, if a layer is said to be formed ‘on’ another layer, then a third layer may be disposed between the two layers or the two layers may be contacted with each other. In other words, it will be understood that when an element such as a layer, film, region, or substrate is referred to as being “on” another element, it can be directly on the other element or intervening elements may also be present.

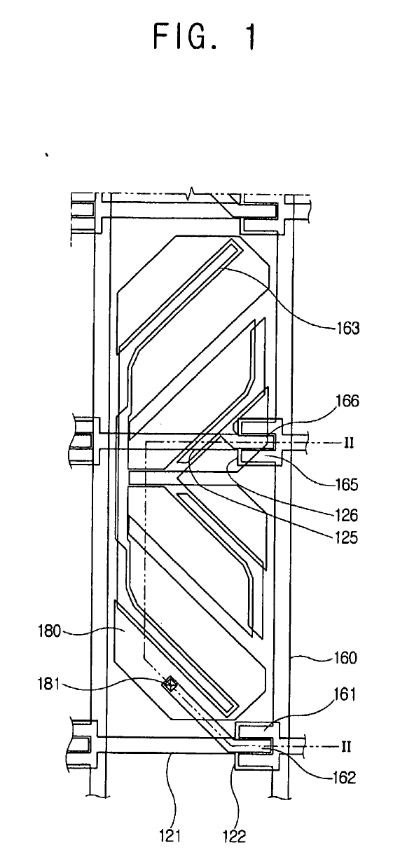

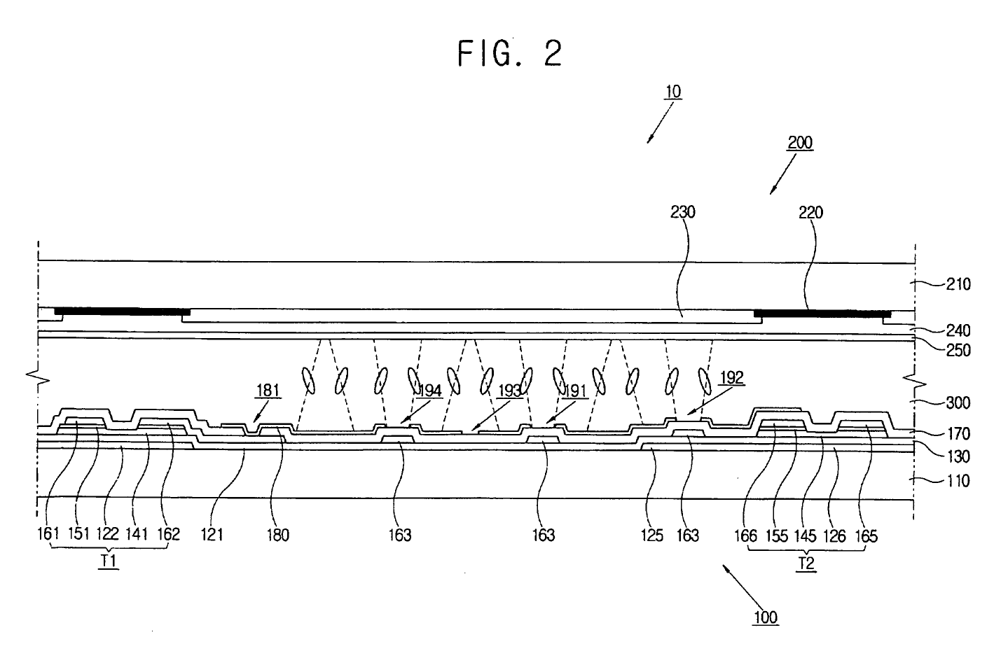

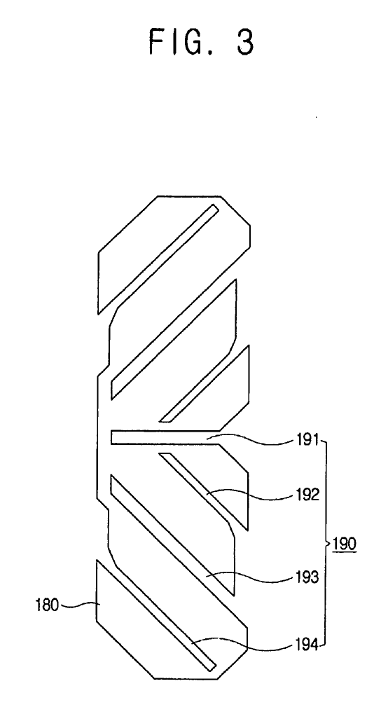

FIG. 1 is an arrangement view of a first exemplary embodiment of a TFT substrate according to the present invention, FIG. 2 is a sectional view of an LCD, taken along line II-II of FIG. 1, and FIG. 3 is a drawing of the first exemplary embodiment of a pixel electrode cutting pattern according to the present invention.

An LCD 10 includes a TFT substrate (a first substrate) 100, a color filter substrate (a second substrate) 200 facing the TFT substrate 100, and a liquid crystal layer 300 interposed therebetween.

First, the TFT substrate 100 will be described as follows.

On a first substrate substance, namely a first insulating substrate 110, is formed a gate line assembly 121, 122, 125, 126. The gate line assembly 121, 122, 125, 126 may be a single-layer or multi-layer structure and may include various metals and alloys. The gate line assembly 121, 122, 125, 126 includes a first gate line 121 formed in the widthwise, or transverse, direction, a first gate electrode 122 connected to the first gate line 121, a second gate line 125 disposed parallel with and spaced a predetermined amount from the first gate line 121, a second gate electrode 126 connected to the second gate line 125, and a storage capacity line (not shown) forming a storage capacity overlapped with a pixel electrode 180.

On the first insulating substrate 110, a gate insulating layer 130 including silicon nitride (SiNx) or other suitable material covers the gate line assembly 121, 122, 125, 126.

On the gate insulating layer 130 and over the gate electrodes 122, 126 are formed a first semiconductor layer 141 and a second semiconductor layer 145, respectively, made of amorphous silicon a-Si or the like. On the semiconductor layers 141, 145 are formed a first ohmic contact layer 151 and a second ohmic contact layer 155, respectively, made of n+ hydrogenated a-Si highly doped with silicide or n-type dopant. It should be understood that doping is the introduction of dopant into a semiconductor for the purpose of altering its electrical properties, where the dopant is an element introduced into the semiconductor to establish either p-type (acceptors, holes) or n-type (donors, free electrons) conductivity. The ohmic contact layer 151, 155 is removed from a channel between a source electrode 161, 165 and a drain electrode 162, 166.

A data line assembly 160, 161, 162, 165, 166 and a direction control electrode line 163 are formed on the ohmic contact layer 151, 155 and on the gate insulating layer 130. The data line assembly 160, 161, 162, 165, 166 may also be single-layer or multi-layer assembly. The data line assembly 160, 161, 162, 165, 166 includes a data line 160 formed in the lengthwise, or longitudinal, direction and is crossed, such as substantially perpendicularly, with the gate line 121, thereby forming a pixel, a first source electrode 161 and a second source electrode 165 which are branches of the data line 160 and which extend over an upper side of the ohmic contact layer 151, 155, and a first drain electrode 162 and a second drain electrode 166 separated from the source electrodes 161, 165 and formed on the ohmic contact layers 151, 155 disposed opposite to the source electrodes 161, 165.

The direction control electrode line 163 includes a part parallel with the data line 160 and a part formed symmetrically up and down in the oblique direction. As illustrated, the part formed symmetrically up and down in the oblique direction may be angled substantially at a 45 degree angle with respect to the data line 160, although other angles may be within the scope of these embodiments. The angled portions of the direction control electrode line 163 include an extended part bent at the end of the part parallel with the data line 160 in the oblique direction and a part extended along, parallel to, the gate line 125, located generally in the middle of the part parallel with the data line 160, and divided in two symmetrically up and down in the oblique direction. That is, the direction electrode line 163 includes a first part parallel with the data line 160, a second part positioned generally perpendicular to the first part and located within a middle of the first part, a third part extending angularly from a first end of the first part, a fourth part extending angularly from the second part, where the fourth part may be parallel to the third part, a fifth part extending angularly from the second part, where the fifth part may be substantially perpendicular to the fourth part, a sixth part extending angularly from a second end of the first part, where the sixth part may be substantially parallel to the fifth part, a seventh part extending from an end of the fourth part, where the seventh part may extend parallel to the first part, and an eighth part extending from an end of the fifth part, where the eighth part may also extend parallel to the first part. The second part may divide the direction control electrode line symmetrically. That is, the third, fourth, and seventh parts may be mirror images of the sixth, fifth, and eighth parts, respectively. Also, the third, fourth, fifth, and sixth parts may extend in a direction forming about a 45 degree angle relative to the second part, although other angles are within the scope of these embodiments. The direction control electrode line 163 may further include a ninth part extending from the fourth part and forming the second drain electrode 166. While a specific arrangement of the direction control electrode line 163 is illustrated and described, it should be understood that the direction control electrode line 163 may be varied to accommodate various LCDs and varying pixel electrode cutting patterns 190, as will be further described below. A symmetrical part up and down in the oblique direction, such as the third, fourth, fifth, and sixth parts, is at least partly overlapped with a pixel electrode cutting pattern 190 formed in the pixel electrode 180. In other words, the portions of the direction control electrode line 163 that are non-perpendicularly angled with respect to the data line 160 overlap with sections of the pixel electrode cutting pattern 190. The direction control electrode line 163 is partly included in a TFT(T2) for a direction control electrode, as will be further described below, thereby functioning as the second drain electrode 166. The direction control electrode line 163 is formed in the same layer as the data line assembly 160, 161, 162, 165, 166. Thus, an additional step during the manufacture of the LCD to form the direction control electrode line 163 is not required.

Here, the width of the direction control electrode line 163 is preferably 1˜16 μm. The direction control electrode line 163 forms a fringe field thereby forming a plurality of domains where liquid crystal molecules in a pixel tilt in different directions. The slanting direction of the liquid, crystal molecules is better controlled to enhance the overall response speed. Likewise, as one pixel is divided into a plurality of domains, an angular field of the LCD broadens out. However, if the width of the direction control electrode line 163 is less than 1 μm, the fringe field may not be properly flown out and a plurality of domains where liquid crystal molecules in a pixel tilt in different directions may not be formed. Also, if the width of that is more than 16 μm, an aperture ratio in a pixel is lowered, that is, the area of a pixel that is transparent to light when the pixel is in an on state is deleteriously reduced if the width of the direction control electrode line 163 is greater than 16 μm. Therefore, the width of the direction control electrode line 163, which is 1˜6 μm, is proper to form the domains where liquid crystal molecules in a pixel tilt in different directions without lowering the aperture ratio.

The direction control electrode line 163 is at least partly overlapped with the pixel electrode cutting pattern 190. The fringe field generated by the direction control electrode 163 is flown out, thereby forming a plurality of domains where liquid crystal molecules in a pixel tilt in different directions. If the direction control electrode line 163 is hidden by a pixel electrode 180, and if the pixel electrode 180 does not include a cutting pattern for revealing the direction control electrode line 163, the fringe field generated by the direction control electrode line 163 would not be properly flown out, that is, strength of the fringe field would become weak, thereby not forming a plurality of domains where liquid crystal molecules in a pixel tilt in different directions. Therefore, the direction control electrode line 163 may be preferably overlapped at least partly with the pixel electrode cutting pattern 190.

Accordingly, the TFT(T2) for the direction control electrode is completed, when providing the second source electrode 165 and the second drain electrode 166, where the second drain electrode 166 and the direction control electrode line 163 are connected to the second gate electrode 126. The TFT(T2) for the direction control electrode is formed on an area where the data line 160 and the second gate line 125 are crossed and applies predetermined voltage to the direction control electrode line 163, thereby forming the fringe field.

On the data line assembly 160, 161, 162, 165, 166 and on the semiconductor layer 141, 145 not hidden by the same is formed a protecting layer 170. On the protecting layer 170 is formed a contact hole 181 through which the first drain electrode 162 is exposed.

On the protecting layer 170 is formed the pixel electrode 180. The pixel electrode 180 may be made of transparent conductive substance such as indium tin oxide (“ITO”) or indium zinc oxide (“IZO”). The pixel electrode 180 is electrically connected with the first drain electrode 162 through the contact hole 181. Further, on the pixel electrode 180 is formed the pixel electrode cutting pattern 190 so that one pixel is divided into a plurality of domains, thereby realizing a wide angular field.

As shown in FIG. 3, the pixel electrode cutting pattern 190 is formed in the extended direction of the gate line 121 and includes a first pixel electrode cutting pattern 191 dividing the pixel electrode 180 in two sections symmetrically up and down, and a second through a fourth cutting patterns 192, 193, 194 of the pixel electrode 180 disposed symmetrically with respect to the first pixel electrode cutting pattern 191 and formed in the oblique directions, respectively. Thus, a first section of the pixel electrode 180 is disposed on one side of the first pixel electrode cutting pattern 191 and a second section of the pixel electrode 180 is disposed on a second side of the first pixel electrode cutting pattern 191. The second, third, and fourth pixel electrode cutting patterns 192, 193, and 194 are symmetrically disposed on both the first and second sections of the pixel electrode 180. In other words, the first section of the pixel electrode 180 may be a mirror image of the second section of the pixel electrode 180. The second pixel electrode cutting pattern 192 is disposed near to the first pixel electrode cutting pattern 191 and the third and the fourth pixel electrode cutting patterns 193, 194 are orderly disposed parallel with the second pixel electrode cutting pattern 192 at a predetermined space respectively. The angles of the second, third, and fourth pixel electrode cutting patterns 192, 193, and 194 may match that of the third through sixth parts of the direction control electrode line 163. For example, the second, third, and fourth pixel electrode cutting patterns 192, 193, and 194 may extend in a direction extending about 45 degrees relative to the first pixel electrode cutting pattern 191, although other angles are within the scope of these embodiments. The first pixel electrode cutting pattern 191 may extend substantially in the same direction as the second part of the direction control electrode line 163.

As illustrated, the direction control electrode line 163 is at least partly overlapped with the first, the second, and the fourth pixel electrode cutting patterns 191, 192, 194. More particularly, the second part of the direction control electrode line 163 is overlapped by the first pixel electrode cutting pattern 191, the third part of the direction control electrode line 163 is overlapped by the fourth pixel electrode cutting pattern 194 in the first section of the pixel electrode 180, the fourth part of the direction control electrode line 163 is overlapped by the second pixel electrode cutting pattern 192 in the first section of the pixel electrode 180, the fifth part of the direction control electrode line 163 is overlapped by the second pixel electrode cutting pattern 192 in the second section of the pixel electrode 180, and the sixth part of the direction control electrode line 163 is overlapped by the fourth pixel electrode cutting pattern 194 in the second section of the pixel electrode 180. Thus, the fringe field is properly flown out, thereby forming a plurality of domains where liquid crystal molecules tilt in the different directions, and the wide angular field may be preferably realized.

To the pixel electrode 180 is applied predetermined voltage by a TFT(T1) for the pixel electrode 180 including the first gate electrode 122, the first source electrode 165, and the first drain electrode 166 thereby realigning the liquid crystal.

While a particular embodiment of the pixel electrode cutting pattern 190 has been illustrated and described, the pixel electrode cutting pattern 190 need not be limited to the shape in the described embodiment, but may instead by formed in various shapes, as may the direction control electrode line 163.

The color filter substrate 200 will now be further described.

On a second substrate substance, namely a second insulating substrate 210, is formed a black matrix 220. The black matrix 220 generally divides a space between red, green, and blue filters and prevents the TFTs disposed on the first substrate, the TFT substrate 100, from directly irradiating light. The black matrix 220 may be made of a photosensitive organic material added with a black pigment, such as carbon black, titanium oxide, etc.

On a color filter layer 230 are repeatedly formed the red, green, and blue filters on a boundary of the black matrix 220. The color filter layer 230 provides light generated from a backlight unit, not shown, and passing through the liquid crystal layer 300 with colors. The color filter layer 230 may be made of a photosensitive organic material.

On the color filter layer 230 and the portions of the black matrix 220 not covered with the color filter layer 230 is formed an overcoat layer 240. The overcoat layer 240 makes the color filter layer 230 flat, thereby protecting the color filter layer 230, and may be made of acryl epoxy material.

A common electrode 250 is formed on the overcoat layer 240. The common electrode 250 is made of a transparent conductive substance such as, but not limited to, ITO, IZO, etc. The common electrode 250 directly applies voltage to the liquid crystal layer 300 together with the pixel electrode 180 of the TFT substrate 100.

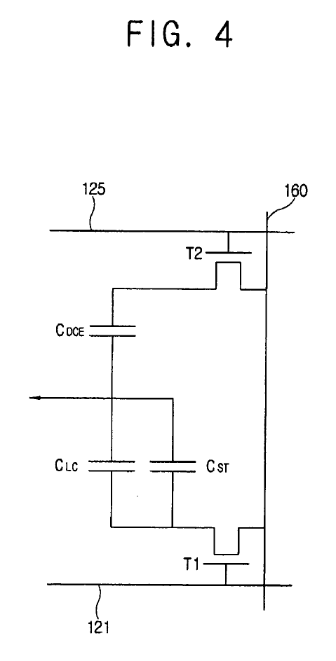

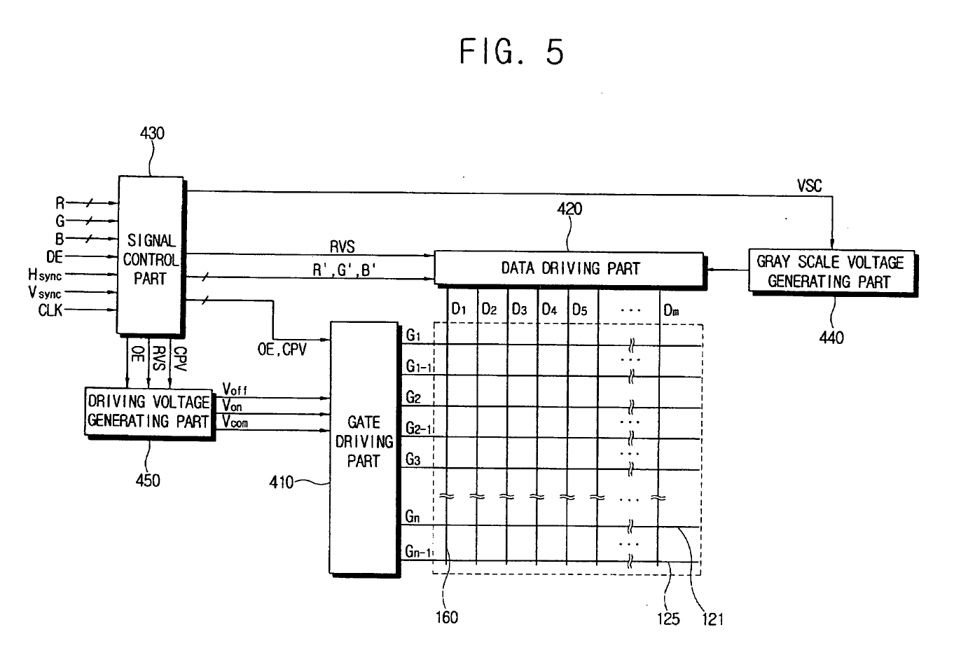

Herein below, a description of how an LCD is driven will be described with reference to FIGS. 4 and 5 according to the present invention. FIG. 4 is a circuit diagram of the exemplary LCD and FIG. 5 is a block diagram showing how a first exemplary embodiment of the LCD is driven according to the present invention.

As shown in FIG. 4, the pixel electrode 180 forms a liquid crystal capacitor together with a common electrode 250 of the color filter substrate 200 and a liquid crystal capacitor is C_{LC}. Also, the pixel electrode 180 forms a storage capacitor together with a storage electrode, not shown in FIG. 1, connected to a storage electrode line and a storage capacitor is C_{ST}. The direction control electrode line 163 forms a direction control capacitor together with the common electrode 250 and a direction control capacitor is C_{DCE}. As described above, a fringe field from the direction control electrode line 163 is flown out through a pixel electrode cutting pattern 190 of the pixel electrode 180, thereby forming a plurality of domains where liquid crystal molecules in a pixel tilt in different directions.

However, to form a plurality of domains where liquid crystal molecules tilt in different directions by the fringe field from the direction control electrode line 163, an electric potential difference between the common electrode 250 and the direction control electrode line 163 is 0.5˜5 Volts more than the electric potential difference between the common electrode 250 and the pixel electrode 180. That is, since a common voltage V_{com} applied to the common electrode 250 is regular, an absolute value of a difference between the voltage applied to the direction control electrode line 163 and the common voltage is preferably larger than an absolute value of a difference between the voltage applied to the pixel electrode 180 and the common voltage. Therefore each pixel is divided into a plurality of domains by the fringe field formed by the direction control electrode line 163 and voltage is applied to the common electrode 250 and to the pixel electrode 180, thereby realigning liquid crystal molecules having a predetermined slant.

A driving principle applying higher electric potential difference to the direction control electrode line 163 is as follows. As shown in FIG. 5, the LCD panel includes a gate driving part 410 applying a gate signal to a gate line 121, 125, a data driving part 420 applying a data signal to a data line 160, and a signal control part 430 controlling the gate driving part 410 and the data driving part 420. Here, a driving voltage generating part 450 generates a gate on voltage Von to allow the TFT(T1,T2) to be turned on, a gate off voltage Voff to allow a switching element to be turned off, and a common voltage Vcom applied to the common electrode 250. Further, a gray scale voltage generating part 440 generates a plurality of gray scale voltages related to brightness of the LCD and provides the data driving part 420 with the gray scale voltage having voltage value decided based on the voltage selection control signal VSC generated by the signal control part 430.

Here, the signal control part 430 applies a voltage to the direction control electrode line 163 0.5V˜5V higher than a voltage applied to the pixel electrode 180. The signal control part 430 controls the data driving part 420 so that a voltage having the same polarity may be applied to the direction control electrode line 163 and the pixel electrode 180. That is, the signal control part 430 controls the gray scale voltage generating part 440, thereby respectively applying the high or low gray scale voltage, based on the voltage selection control signal VSC, to the data driving part 420. Accordingly, the data driving part 420 applies high voltage to the direction control electrode line 163 and low voltage to the pixel electrode 180.

Also, the signal control part 430 controls the gate driving part 410 so that the TFT(T2) for the direction control electrode is turned on before the TFT(T1) for the pixel electrode 180 is turned on and the TFT(T2) for the direction control electrode is turned off before the TFT(T1) for the pixel electrode 180 is turned on. Here, the TFT(T1) for the pixel electrode 180 and the TFT(T2) for the direction control electrode are preferably driven independently.

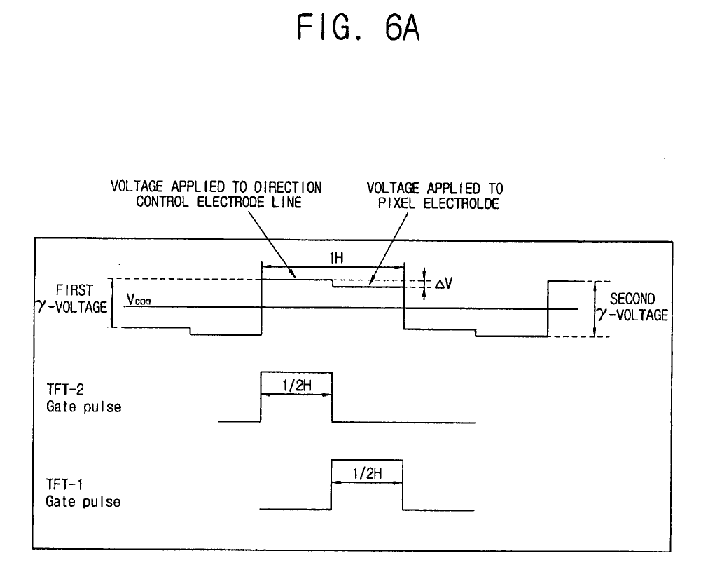

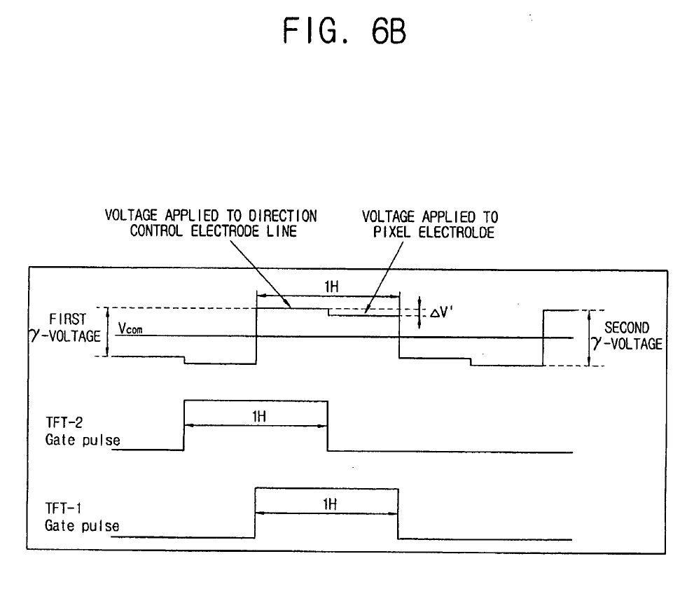

Hereinafter, an exemplary driving method according to the first embodiment of the present invention will be described with reference to FIGS. 6A and 6B. FIG. 6A shows how a data signal and a gate signal are applied when a single gate is driven and FIG. 6B shows how a data signal and a gate signal are applied when a dual gate is driven.

As shown in FIG. 6A, in an upper graph showing a signal applied to a data line 160, a first γ-voltage is a picture signal applied to a pixel electrode 180 and a second γ-voltage is a direction control signal applied to a direction control electrode line 163. A middle graph shows the gate signal applied to a TFT(T2) for a direction control electrode and a lower graph shows a gate signal applied to a TFT(T1) for a pixel electrode 180. As shown in the graphs, the direction control signal applied to the direction control electrode line 163 rises and falls before the picture signal applied to the pixel electrode 180 does at a predetermined time, voltage applied to the direction control electrode line 163 is ΔV more than the voltage applied to the pixel electrode 180. ΔV is between 0.5 and 5V. Here, a single gate driving is a method controlled by a single gate signal divided into two signals controlling the two TFTs, thereby allowing the TFT(T2) for the direction control electrode and the TFT(T1) for the pixel electrode 180 to be turned on respectively at regular intervals. Provided that a time when the data signal (the first γ-voltage and the second γ-voltage) is applied to a single pixel is 1 H, the TFT(T2) for the direction control electrode is first turned on as long as ½ H, thereafter the TFT(T1) for the pixel electrode 180 is turned on as long as ½ H. That is, when the TFTs (T1, T2) are respectively turned on at regular intervals, the picture signal and the direction control signal are respectively applied to the pixel electrode 180 and the direction control electrode line 163 thereby applying predetermined voltage to the pixel electrode 180 and the direction control electrode line 163. In this case, since the TFTs respectively apply the picture signal applied to the pixel electrode 180 and the direction control signal applied to the direction control electrode line 163 at regular intervals so as not to overlap each other, ΔV may be 0. That is, after first applying voltage to the direction control electrode line 163 at regular intervals, thereby forming a plurality of domains where liquid crystal molecules tilt in different directions, and then applying the same voltage to the pixel electrode 180, the liquid crystal molecules may be realigned.

As shown in FIG. 6B, the upper graph shows data signals (pixel signal, direction control signal) applied to a data line 160, a middle graph shows a gate signal applied to the TFT(T2) for a direction control electrode, and a lower graph shows a gate signal applied to a TFT(T1) for a pixel electrode 180. A dual gate driving is a method applying two gate signals in order to control the two TFTS. It is the same as the single gate driving method, but separately applies each gate signal to the TFT(T2) for the direction control electrode and the TFT(T1) for the pixel electrode 180 respectively. In this case, since the time for each gate signal applied is overlapped, different gate signals are applied to the TFTs, thereby generating a voltage difference (ΔV′). ΔV′ may be between 0.5 and 5V.

As for the first exemplary embodiment of the abovementioned LCD according to the present invention, a fringe field is flown out by the direction control electrode line 163, thereby forming a plurality of domains where liquid crystal molecules in a pixel tilt in different directions, thereafter a predetermined voltage is applied to the pixel electrode 180, thereby realigning the liquid crystal molecules to display an image. Accordingly, a pixel is divided into a plurality of domains by a pixel electrode cutting pattern 190 and the direction control electrode line 163 and alignment of the liquid crystal molecules is different from each domain, therefore, a wide angular field may be realized.

Also, since a dissection pattern is not provided on a common electrode 260, a series of process such as a developer-coating, a developing, etching, etc. are omitted, thereby improving a process efficiency and decreasing a manufacturing cost.

Moreover, a TFT leakage problem may be settled, providing an improvement over a conventional structure. That is, in a structure forming a TFT for a pixel electrode driving a foregoing-part pixel and a TFT for a direction control electrode forming a domain of a latter-part pixel, higher voltage was applied to the TFT for the direction control electrode than to the TFT for the pixel electrode of the foregoing-part pixel in order to apply high voltage to the direction control electrode line of the latter-part pixel. In this case, there was a TFT leakage problem, where voltage applied to the TFT for the direction control electrode of the latter-part is flown backward to the TFT for the pixel electrode of the foregoing-part. For this reason, since the desired voltage may not be applied to the direction control electrode line, there are problems, that is, one pixel may not be divided into a plurality of domains or high voltage may be used.

However, in an LCD according to the present invention, a plurality of gate line assemblies are provided and on each gate line assembly are formed a TFT (T1) for a pixel electrode 180 and a TFT (T2) for a direction control electrode, thereby settling the abovementioned problems.

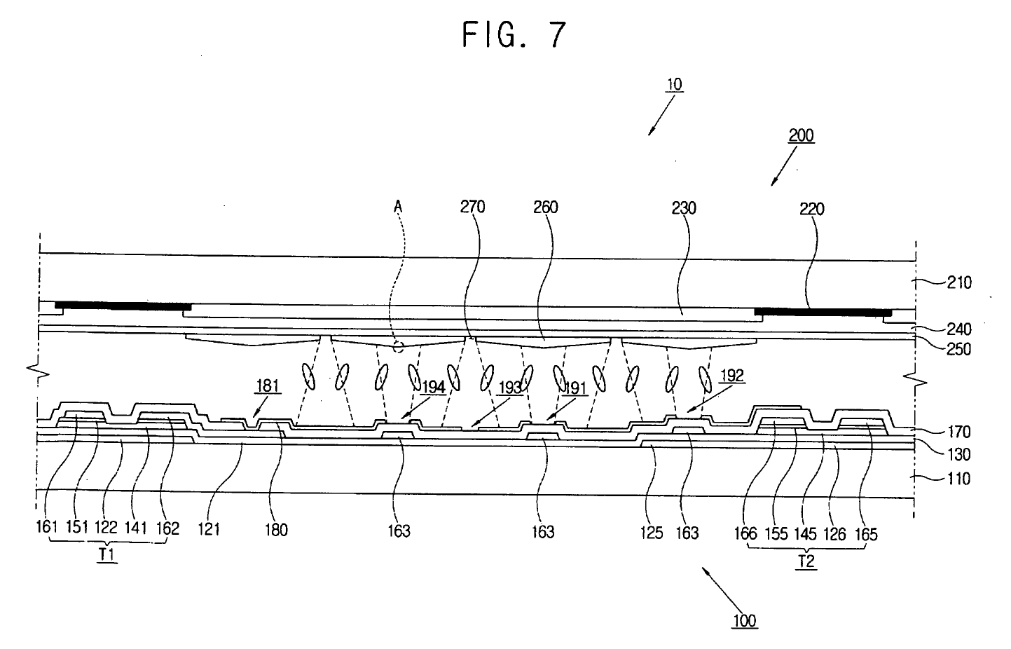

FIG. 7 is a sectional view of a second exemplary embodiment of an LCD according to the present invention. As shown in FIG. 7, on a common electrode 250, formed in an entire pixel area, is provided an organic layer mountain structure-type pattern 260. That is, the common electrode 250 is not provided with any cutting pattern apart from a conventional common electrode. The organic layer mountain structure-type pattern 260 is in a mountain shape having a predetermined slant, thus having a substantially triangular shaped cross-section, and is an organic layer projected toward the TFT substrate 100. A shape of the organic layer mountain structure-type pattern 260 is respectively separated by an organic layer cutting pattern 270. As shown in FIG. 7, part ‘A’ is a top of the organic layer mountain structure-type pattern 260 preferably formed corresponding to a direction control electrode line 163 of the first substrate 100. That is, the organic layer mountain structure-type pattern 260 is preferably disposed corresponding to first, second, and fourth pixel electrode cutting patterns 191, 192, 194, where the second through sixth parts of the direction control electrode line 163 are positioned there below. More particularly, the peak of each organic layer mountain structure-type pattern 260 is aligned over the first, second, and fourth pixel electrode cutting patterns 191, 192, and 194.

Further, the organic layer mountain structure-type pattern 260 is preferably formed in a taper structure becoming gradually thinner from the top to a verge, and a slant of the taper may be in a range of from about 1 to about 5 degrees. The thickness of the top of the organic layer mountain structure-type pattern of the 260 is preferably in a range of from about 0.5 to about 3 μm. The organic layer mountain structure-type 260 may be formed by controlling an exposure degree and a developing process.

Providing the abovementioned organic layer mountain structure-type pattern 260 makes the fringe field strong, thereby forming a plurality of domains in a pixel, when the fringe field is weakly flown out by the direction control electrode line 163 and a plurality of domains where liquid crystal molecules tilt in different directions are not formed. Furthermore, when the liquid crystal molecules have a predetermined pretilt by the organic layer mountain structure-type pattern 260, thereby applying voltage to the pixel electrode 180, they are quickly realigned by the pretilt.

Here, the slant and the thickness of the taper of the organic layer mountain structure-type pattern 260 are limited to accomplish the following effect. In the present invention, since the common electrode 260 does not have a cutting pattern, a process efficiency may be improved and a manufacturing cost may be decreased by omitting the processing steps involving a developer-coating, a developing, and an etching. Moreover, the fringe field becomes strong by the organic layer mountain structure-type pattern 260, thereby forming a plurality of domains where the liquid crystal molecules tilt in different directions. Thus, when the liquid crystal molecules are given the pretilt and voltage is applied to the pixel electrode 180, the liquid crystal molecules are quickly realigned, thereby improving a response time.

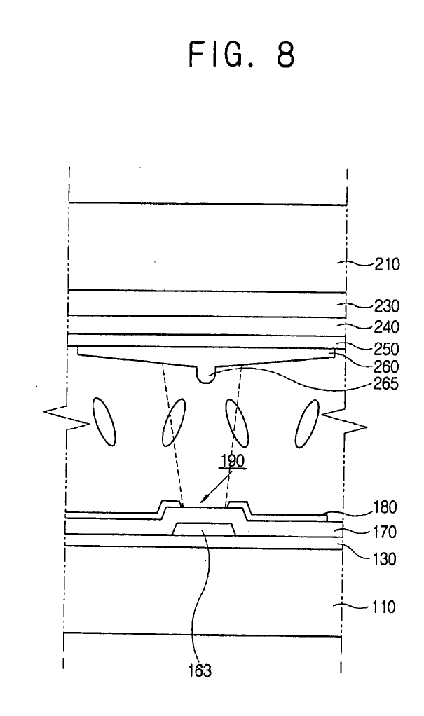

FIG. 8 is a sectional view of a third exemplary embodiment of an LCD according to the present invention. On the top of an organic layer mountain structure-type pattern 260 is provided a projection 265 projected in a direction towards the first insulating substrate 110 as shown in FIG. 8, thereby strengthening a fringe field. The projection 265 may be provided to realize a wide angular field and to improve a response time when a fringe field is weak even by an aforementioned direction control electrode line 163 and the organic layer mountain structure-type pattern 260, or when liquid crystal molecules are not properly given a pretilt, thereby insufficiently improving the response time. The projection 265 is provided by controlling an exposure and development when the organic layer mountain structure-type pattern 260 is formed. Accordingly, as the fringe field becomes stronger, the response time of a liquid crystal in a liquid crystal layer 300 is improved and a pixel is divided into a plurality of domains having a different alignment of the liquid crystal, thereby realizing a wide angular field.

Meanwhile, although not shown in the Figures, when the organic layer mountain structure-type pattern 260 or a projection 265 is provided, a column spacer may be also provided. The column spacer is formed to maintain a cell gap between a TFT substrate 100 and a color filter substrate 200. The column spacer may be substantially formed in a shape of a cylinder, a truncated cone, or a half sphere on the second substrate 200 corresponding to a TFT, a gate line assembly, a data line assembly, and a crossing point of the gate line assembly and the data line assembly formed on the first substrate 100. Accordingly, the organic layer mountain structure-type pattern 260, the projection 265, and the column spacer may be formed in a process at substantially the same time, thereby efficiently reducing the manufacturing process of the LCD.

Hereinafter, an exemplary method of manufacturing an exemplary embodiment of the LCD according to the present invention will be briefly described with reference to the Figures.

First, an exemplary method of manufacturing a first exemplary embodiment of the LCD according to the present invention will be described with reference to FIG. 2. After a gate line assembly substance is deposited on a first insulating substrate 110 and is patterned by a photolithography process using a mask, a gate line assembly 121, 122, 125, 126 having gate lines 121, 125 and gate electrodes 122, 126 is formed. Here, the gate lines 121, 125 are formed mutually parallel at a predetermined distance in a width direction in a single pixel. Further, the gate electrodes 122, 126 are formed connecting with the gate lines to be widely expanded. A gate insulating layer 130, semiconductor layers 141, 145 and ohmic contact layers 151, 155 are deposited continually. Then, the semiconductor layers 141, 145 and the ohmic contact layers 151, 155 are patterned by photolithography, to thereby form the semiconductor layers 141, 145 and the ohmic contact layers 151, 155 in an island shape on the gate insulating layer 130 on the gate electrodes 122, 126.

Next, a data line assembly substance is deposited and then patterned by a photolithography process using a mask to thereby form a data line assembly 160, 161, 162, 165, 166 and a direction control electrode line 163. The data line assembly 160, 161, 162, 165, 166 including a data line 160 crossed with the gate lines 121, 125, source electrodes 161, 165 connected to the data line 160 and extended over the gate electrodes 122, 126, and drain electrodes 162, 166 opposite to the source electrodes 161, 165. The direction control electrode line 163 forms a part parallel with the data line 160 and a symmetrical part up and down in the oblique direction, which include an extended part bent at the end of a part parallel with the data line 160 in the oblique direction and a part extended along the gate lines 122, 125 in the middle of a part parallel with the data line 160 and divided in two symmetrically up and down in the oblique direction. The direction control electrode line 163 may include the plurality of first through eighth parts as illustrated and as previously described. The symmetrical part up and down in the oblique direction may be at least partly overlapped with a pixel electrode cutting pattern 190. Moreover, the direction control electrode line 163 is partly extended to function as a second drain electrode 166 by being included in a TFT(T2) for a direction control electrode. The direction control electrode line 163 may be formed with the data line assembly 160, 161, 162, 165, 166 at substantially the same time. Here, width of the direction control electrode line 163 may preferably be 1 to 16 μm.

Accordingly, a TFT(T1) for a pixel electrode 180 controlling the pixel electrode 180 and a TFT(T2) for a direction control electrode controlling the direction control electrode line 163 are completed.

Continuingly, the ohmic contact layers 151, 155 where the data line assembly 160, 161, 162, 165, 166 is not deposited is etched, thereby being separated with respect to the gate electrodes 122, 126 and exposing the semiconductor layers 141, 145 between the opposite ohmic contact layers 151, 155. That is, the first ohmic contact layer 151 includes a contact region exposing the first semiconductor layer 141 there below and the second ohmic contact layer 155 includes a contact region exposing the second semiconductor layer 145 there below.

Next, a protecting layer 170 is formed. The protecting layer 170 is formed by using silicon source gas and nitrogen source gas through a plasma enhanced chemical vapor deposition (“PECVD”) method. On the protecting layer 170 is formed a contact hole 181 exposing the first drain electrode 162. Then, a pixel electrode 180 having a pixel electrode cutting pattern 190 is formed. The pixel electrode cutting pattern 190 includes a first pixel electrode cutting pattern 191 dividing the pixel electrode 180 in two symmetrically up and down sections in the extended direction of the gate line 121, second through fourth cutting patterns 192, 193, 194 of the pixel electrode 180 symmetrically disposed with respect to the first pixel electrode cutting pattern 191 and formed in the oblique directions respectively. The second pixel electrode cutting pattern 192 is disposed near to the first pixel electrode cutting pattern 191, and the third and the fourth pixel electrode cutting patterns 193, 194 are orderly disposed parallel with the second pixel electrode cutting pattern 192 at predetermined spaces respectively. As previously described, the direction control electrode line 163 is at least partly overlapped with the first, the second, and the fourth pixel electrode cutting patterns 191, 192, 194.

Thus, the first substrate, the TFT substrate 100, according to the first embodiment of the present invention is completed.

A color filter substrate 200 may be manufactured by the publicly notified method and the common electrode 250 need not be formed with a dissection pattern. Thereafter, when disposing the TFT substrate 100 and the color filter substrate 200 facing each other, interposing a liquid crystal layer 300 between the two substrates, and going through the module process, the LCD is then completed.

A fringe field is flown out by the direction control electrode line 163, thereby forming a plurality of domains where liquid crystal molecules in a pixel tilt in different directions, thereafter predetermined voltage is applied to the pixel electrode 180, thereby realigning the liquid crystal molecules to display an image. Accordingly, a pixel is divided into a plurality of domains by a pixel electrode cutting pattern 190 and the direction control electrode line 163 and the liquid crystal molecules in the liquid crystal layer 300 are differently aligned in each domain, therefore, a wide angular field may be realized.

Also, since common electrode 250 is not provided with a dissection pattern, a series of processes such as processes involving a developer-coating, a developing, etching, etc. are omitted, thereby improving a process efficiency and decreasing a manufacturing cost.

A method of manufacturing an LCD according to second and third embodiments will be described with reference to FIGS. 7 and 8. Manufacturing a first substrate 100 is followed according to the first embodiment and manufacturing a second substrate 200 which is not described is followed according to the publicly notified method.

As shown in FIGS. 7 and 8, a common electrode 250 is coated with an organic substance, exposed and developed, thereby forming an organic layer mountain structure-type pattern 260. A top of the organic layer mountain structure-type pattern 260 is formed corresponding to a direction control electrode line 163 of the first substrate 100, as previously described. Further, the organic layer mountain structure-type pattern 260 is preferably formed in a taper structure, having a substantially triangular cross-section, becoming gradually thinner from the top to a verge, where the slant of the taper may be in a range of from about 1 to about 5 degrees. The thickness of the top of the organic layer mountain structure-type 260 is preferably in a range of from about 0.5 to about 3 μm. The organic layer mountain structure-type 260 may be formed by controlling an exposure degree and a developing process.

Here, a projection 265 shown in the third embodiment, as illustrated in FIG. 8, may be formed by using an exposure degree and a developing process.

Thereafter, adhering the first and the second substrates 100, 200, interposing the liquid crystal layer 300 between the two substrates 100, 200, and going through the module process, thereby completes the LCD.

When the fringe field is weakly flown out by the direction control electrode line 163 and a plurality of domains where liquid crystal molecules tilt in different directions are not formed, the organic layer mountain structure-type pattern 260 described in the second embodiment, illustrated in FIG. 7, makes the fringe field strong, thereby a pixel is divided into a plurality of domains by a pixel electrode cutting pattern 190 and the direction control electrode line 163 and the liquid crystal molecules are differently aligned in each domain, therefore, a wide angular field may be realized.

When the liquid crystal molecules are given the pretilt by the organic layer mountain structure-type pattern 260 and predetermined voltage is applied to the pixel electrode 180, the liquid crystal molecules are quickly realigned, thereby improving a response time.

Also, if a fringe field is weak even when employing the organic layer mountain structure-type pattern 260, if the projection 265 as described in the third embodiment illustrated in FIG. 8 is formed, the fringe field may be strongly flown out by the direction control electrode line 163. Accordingly, a pixel is divided into a plurality of domains and the liquid crystal molecules are differently aligned in each area, therefore, a wide angular field may be realized.

Furthermore, when the liquid crystal molecules are given the pretilt and voltage is applied to the pixel electrode 180, the liquid crystal molecules are quickly realigned, thereby improving a response time. Further, since a cutting pattern need not be formed on common electrode 260, a series of processes such as processes involving a developer-coating, a developing, etching, etc. may be omitted, thereby improving a process efficiency and decreasing a manufacturing cost.

Meanwhile, in a manufacturing method according to the second and third embodiments, when the organic layer mountain structure-type pattern 260 or the projection 265 is provided, a column spacer may be also provided. The column spacer is formed in a shape substantially that of a cylinder, a truncated cone, or a half sphere on a second substrate 200 and corresponding to a TFT, a gate line assembly, a date line assembly, and a crossing point of the gate line assembly and the date line assembly formed on the first substrate 100. Accordingly, the organic layer mountain structure-type pattern 260, the projection 265 and the column spacer are formed in a process at substantially the same time, thereby efficiently reducing the process.

Although a few embodiments of the present invention have been shown and described, it will be appreciated by those skilled in the art that changes may be made in these embodiments without departing from the principles and spirit of the invention, the scope of which is defined in the appended claims and their equivalents. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A liquid crystal display comprising:
a first insulating substrate;
a second insulating substrate;
a liquid crystal layer disposed between the first insulating substrate and the second insulating substrate;
a first gate line and a second gate line formed on the first insulating substrate in a widthwise direction;
a data line crossed with and insulated from the gate lines, thereby defining a pixel area;
a pixel electrode formed in the pixel area and comprising a pixel electrode cutting pattern;
a direction control electrode line electrically separated from the pixel electrode, at least partly overlapped with the pixel electrode cutting pattern, and controlling the liquid crystal layer;
a first thin film transistor for the pixel electrode formed in an area where the first gate line and the data line are crossed and connected to the pixel electrode; and
a second thin film transistor for a direction control electrode formed in an area where the second gate line and the data line are crossed and connected to the direction control electrode line.

2. The liquid crystal display according to claim 1, wherein the pixel electrode cutting pattern comprises a first pixel electrode cutting pattern formed substantially parallel to the second gate line and dividing the pixel electrode symmetrically in two sections up and down, and a second pixel electrode cutting pattern, a third pixel electrode cutting pattern, and a fourth pixel electrode cutting pattern formed in an oblique direction and divided in two symmetrically up and down by the first pixel electrode cutting pattern on the pixel electrode.

3. The liquid crystal display according to claim 2, wherein the second pixel electrode cutting pattern is disposed near to the first pixel electrode cutting pattern, and the third pixel electrode cutting pattern and the fourth pixel electrode cutting pattern are disposed parallel with and spaced from the second pixel electrode cutting pattern.

4. The liquid crystal display according to claim 3, wherein the direction control electrode line is at least partly overlapped with the first, the second, and the fourth pixel electrode cutting patterns.

5. The liquid crystal display according to claim 1, wherein the direction control electrode line comprises one part parallel with the data line and another part extended in an oblique direction and overlapped with the pixel electrode cutting pattern.

6. The liquid crystal display according to claim 1, wherein the direction control electrode line and the data line are formed in a same layer of the liquid crystal display.

7. The liquid crystal display according to claim 1, wherein the second thin film transistor comprises a gate electrode connected to the second gate line, a source electrode branched off from the data line and formed on the gate electrode, and a drain electrode disposed opposite to the source electrode, and the direction control electrode line is connected to the drain electrode.

8. The liquid crystal display according to claim 7, wherein the gate electrode, the source electrode, and the drain electrode of the second thin film transistor are a second gate electrode, a second source electrode, and a second drain electrode, and the first thin film transistor includes a first gate electrode connected to the first gate line, a first source electrode branched off from the data line and formed on the first gate electrode, and a first drain electrode disposed opposite to the first source electrode, and the pixel electrode is connected to the first drain electrode.

9. The liquid crystal display according to claim 1, wherein width of the pixel electrode cutting pattern and width of the direction control electrode line are in a range of from about 1 to about 16 μm.

10. The liquid crystal display according to claim 1, further comprising a gate driving part applying a gate signal to the gate lines; a data driving part applying a data signal to the data line; and a signal control part controlling the gate driving part and the data driving part, wherein the signal control part controls the data driving part so that voltage applied to the direction control electrode line is about 0.5 to about 5V higher than voltage applied to the pixel electrode.

11. The liquid crystal display according to claim 10, wherein the signal control part controls the data driving part so that the direction control electrode line and the pixel electrode are applied with voltage having same polarity.

12. The liquid crystal display according to claim 10, wherein the signal control part controls the gate driving part so that the second thin film transistor turns on before the first thin film transistor turns on and the second thin film transistor turns off before the first thin film transistor turns off.

13. The liquid crystal display according to claim 10, wherein the signal control part controls the gate driving part so that the gate signal applied to the second thin film transistor rises and falls before the gate signal applied to the first thin film transistor rises and falls.

14. The liquid crystal display according to claim 1, wherein the first thin film transistor and the second thin film transistor are driven independently.

15. The liquid crystal display according to claim 1, further comprising a common electrode disposed opposite to the first insulating substrate and formed on the second insulating substrate, and an organic layer mountain structure-type pattern formed on the common electrode and projected to the first insulating substrate with a mountain shape having a predetermined slant.

16. The liquid crystal display according to claim 15, wherein the mountain shape has a substantially triangular-shaped cross section.

17. The liquid crystal display according to claim 15, wherein the organic layer mountain structure-type pattern is divided apart by an organic layer cutting pattern in a predetermined shape.

18. The liquid crystal display according to claim 15, wherein a top of the organic layer mountain structure-type pattern is formed corresponding to a location of the direction control electrode line.

19. The liquid crystal display according to claim 15, wherein the common electrode is formed on an entire area of the pixel area.

20. The liquid crystal display according to claim 15, wherein the organic layer mountain structure-type pattern is formed in a taper structure becoming gradually thinner from the top to a verge.

21. The liquid crystal display according to claim 15, wherein a slant of a taper of the organic layer mountain structure-type pattern is in a range of from about 1 to about 5 degrees.

22. The liquid crystal display according to claim 15, wherein a thickness of a top of the organic layer mountain structure-type pattern is in a range of from about 0.5 to about 3 μm.

23. The liquid crystal display according to claim 15, wherein a projection projected to the first insulating substrate is formed on a portion of the organic layer mountain structure-type pattern.

24. The liquid crystal display according to claim 23, wherein a part of the projection is aligned with the direction control electrode line.

25. The liquid crystal display according to claim 1, further comprising a common electrode disposed opposite to the first insulating substrate and formed on the second insulating substrate, and a column spacer projected to the first insulating substrate and formed on the common electrode.

26. The liquid crystal display according to claim 25, wherein the column spacer is formed corresponding to at least one place among the thin film transistors formed on the first insulating substrate, the gate lines, the data line, and an area where the gate lines and the data line are crossed.

27. A thin film transistor substrate comprising:
an insulating substrate;
a first gate line and a second gate line formed on the insulating substrate in a width direction;
a data line crossed with and insulated from the gate lines, thereby defining a pixel area;
a pixel electrode formed in the pixel area and comprising a pixel electrode cutting pattern;
a direction control electrode line electrically separated from the pixel electrode, at least partly overlapped with the pixel electrode cutting pattern and controlling a liquid crystal layer;
a first thin film transistor for the pixel electrode formed in an area where the first gate line and the data line are crossed and connected to the pixel electrode; and
a second thin film transistor for a direction control electrode formed in an area where the second gate line and the data line are crossed and connected to the direction control electrode line.

28. A method of manufacturing a liquid crystal display comprising:
providing a first insulating substrate and a second insulating substrate;
forming a first gate line and a second gate line spaced apart by a predetermined distance on the first insulating substrate;
providing a data line crossed with and insulated from the first gate line and the second gate line, thereby defining a pixel area, a first thin film transistor for a pixel electrode disposed on an area where the first gate line is crossed with the data line, and a second thin film transistor for a direction control electrode comprising a portion of the direction control electrode line disposed on an area where the second gate line is crossed with the data line;
forming a pixel electrode comprising a pixel electrode cutting pattern; and
interposing a liquid crystal layer between the first insulating substrate and the second insulating substrate.

29. The method of manufacturing a liquid crystal display according to claim 28, wherein forming a pixel electrode comprising a pixel electrode cutting pattern comprises forming a first pixel electrode cutting pattern formed substantially parallel to the gate lines and dividing the pixel electrode symmetrically in two sections up and down, and forming a second pixel electrode cutting pattern, a third pixel electrode cutting pattern, and a fourth pixel electrode cutting pattern in an oblique direction and divided in two symmetrically up and down by the first pixel electrode cutting pattern on the pixel electrode.

30. The method of manufacturing a liquid crystal display according to claim 29, wherein forming the pixel electrode further comprises providing the second pixel electrode cutting pattern next to the first pixel electrode cutting pattern and providing the third pixel electrode cutting pattern and the fourth pixel electrode cutting pattern parallel with and spaced from the second pixel electrode cutting pattern.

31. The method of manufacturing a liquid crystal display according to claim 29, further comprising forming the direction control electrode line to be at least partly overlapped with the first, the second, and the fourth pixel electrode cutting pattern.

32. The method of manufacturing a liquid crystal display according to claim 28, further comprising forming the direction control electrode line with one part parallel with the data line and another part extended in an oblique direction and overlapped with the pixel electrode cutting pattern.

33. The method of manufacturing a liquid crystal display according to claim 28, further comprising forming the direction control electrode line and the data line at a same time.

34. The method of manufacturing a liquid crystal display according to claim 28, further comprising forming a common electrode on the second insulating substrate and an organic layer mountain structure-type pattern on the common electrode and projected to the first insulating substrate with a mountain shape having a predetermined slant.

35. The method of manufacturing a liquid crystal display according to claim 34, further comprising forming a projection projected to the first insulating substrate on a portion of the organic layer mountain structure-type pattern.

36. The method of manufacturing a liquid crystal display according to claim 35, wherein forming the projection comprises forming the projection on a portion of the organic layer mountain structure-type pattern positioned closest to the first insulating substrate.

37. The method of manufacturing a liquid crystal display according to claim 35, wherein forming the projection comprises aligning a part of the projection with the direction control electrode line.

38. The method of manufacturing a liquid crystal display according to claim 28, further comprising forming a common electrode on the second insulating substrate and forming a column spacer projected to the first insulating substrate on the common electrode.

39. The method of manufacturing a liquid crystal display according to claim 38, wherein forming the column spacer includes forming the column spacer in a location corresponding to at least one place among the thin film transistors formed on the first insulating substrate, the data line, the gate lines, and an area where the gate lines and the data line are crossed.

40. The method of manufacturing a liquid crystal display according to claim 38, wherein forming the column spacer includes forming the column spacer with the organic layer mountain structure-type pattern or the projection at a substantially same time.

41. The method of manufacturing a liquid crystal display according to claim 28, further comprising forming the direction control electrode line at a substantially same time as providing the data line.
